(19) United States
(12) Patent Application Publication
(10) Pub. No.: US 2024/0165929 A1
(43) Pub. Date: May 23, 2024

(54) BIOMASS-DERIVED POLYMER AND CELLULOSE MATERIAL COMPOSITION FOR INSULATION

(71) Applicant: CLEANFIBER INC., Blasdell, NY (US)

(72) Inventors: Jonathan Strimling, Bedford, NH (US); Michael Bilodeau, Clermont, FL (US); Randell Drane, Winchester, MA (US); Nicholas Yardy, Portland, ME (US)

(73) Assignee: CLEANFIBER INC., Blasdell, NY (US)

(21) Appl. No.: 18/281,820

(22) PCT Filed: Mar. 14, 2022
(86) PCT No.: PCT/US22/20260

§ 371 Date: Sep. 13, 2023

Related U.S. Application Data
(60) Provisional application No. 63/160,802, filed on Mar. 13, 2021.

(51) Int. Cl. B32B 27/06; B32B 29/00; B32B 29/06; B32B 38/00

(52) U.S. Cl. CPC B32B 27/065; B32B 29/007; B32B 29/06; B32B 38/0004; B32B 2307/3065; B32B 2317/122; B32B 2317/18

(57) ABSTRACT

An insulation composition including a biomass-derived polymer, a cellulose component, and a fire retardant applied to at least a portion of either or both of the biomass-derived polymer and the cellulose component. The biomass-derived polymer may be used to bind the cellulose component. The cellulose component may be fibers, cellulose dust, nanocrystalline structure, or a combination. The insulation composition may be formed into batts, assemblies, or boards. The insulation composition may be processed in the field by shredding to form loose fill insulation. The composition may be treated with one or more additives, including an expansion component selected to reduce the density of the composition.

### BACKGROUND OF THE INVENTION

### 1. Field of the Invention

The present invention relates to insulation made partially or entirely of a composition of biomass-derived polymer and cellulose. More particularly, the present invention relates to the formation of such polymer/cellulose composition-based insulation in the field from a polymer/cellulose composition.

### 2. Description of the Prior Art

Existing cellulose insulation is shredded, treated, fiberized, and packaged in a central plant. The bags are then distributed to users who open the bag, add the contents to an installation machine, such as a blower arranged to re-aerate cellulose fibers that were compressed in the packaging process, and blowing them into their installed positions. The existing process for making and packaging the cellulose insulation can be expensive. In addition, the re-aeration and installation of the insulation fibers can be time consuming and labor intensive. It would be preferable to make the cellulose insulation in the field.

There has been an increase in efforts to develop environmentally friendly insulation that is relatively inexpensive and relatively easy to deploy. Existing insulation materials have undesirable characteristics including chemical compounds such as Volatile Organic Compounds (VOC) and formaldehyde but not limited thereto. However, they are relatively inexpensive, effective at insulating, and fairly easy to deploy. Cellulose insulation can be a reasonable substitute and is less harmful.

What is needed is a cellulose-based composition that can be used in the field to provide effective insulation. More particularly, what is needed is a cellulose-based composition available in any selectable form suitable for particular insulation needs. Further, what is needed is an effective insulation product with good environmental characteristics. The composition should be suitable as a precursor material for insulation fabrication.

### SUMMARY OF THE INVENTION

The present invention is a composition of a biomass-derived polymer and a cellulose component that when combined together form a polymer-cellulose insulation composition. The invention is an insulation composition including one or more biomass-derived polymer components, one or more cellulose components, and one or more fire retardants applied to at least a portion of either or both of the one or more biomass-derived polymer components and the one or more cellulose components. The invention is also a method to make an insulation composition of one or more biomass-derived polymer components, one or more cellulose components, and one or more fire retardants, by binding a plurality of cellulose components together with a biomass-derived polymer to form a polymer-cellulose composition and adding a fire retardant to one or more of the cellulose components, the biomass-derived polymer, and the polymer-cellulose composition. The composition in readily transportable form, such as in sheets or rolls but not limited thereto, can be used to make the insulation on site where a structure to be insulated exists. The composition may be processed in a remote location to allow the formation of a biomass-derived polymer/cellulose-based insulation with different properties than the composition, which are advantageous for insulation applications, such as low bulk density, high thermal resistance, low adverse environmental impact, fungal resistance, specific barrier properties and/or low dust and residues.

The composition may also include one or more optional additives selected to enable expansion of the composition at the point of manufacturing, at the point of distribution, or at the point of end-use to reduce its density structure. The composition may be formed into sheets or rolls for cost-effective delivery to a distribution site or end-use site. The composition in compacted form can be shipped from a manufacturer to a distributor for further processing, including optional expansion, by the distributor prior to delivery to an end-use site. The composition may also be shipped directly to the end-use site and optionally expanded by the end user.

The biomass-derived polymer of the composition may be any one or more of polyester, polyethylene terephthalate (PET), polyethylene, polypropylene, or others. The polymer may be in fiber form, ribbon form, or other desirable form. The polymer may be treated with one or more additives. One such additive may be a fire resistance additive, such as a borate but not limited thereto. The polymer fibers, ribbons, etc., may be made by extruding melted polymer into strands that may be cut or otherwise modified to a selectable length. The polymer fibers may be formed into one or more selectable shapes. Such shapes include, but are not limited to, hollow tube, hollow square, or other hollow shape. They may be I-, E-, W-, X-, or Y-shaped.

The fibers may be treated with an additive such as a fire-resistant additive such as borate during or after fiber formation. For example, the melt temperature used to melt the polymer material prior to delivery to a spinneret may be selected to be high enough to provide a sticky surface that a borate additive adheres to but low enough to maintain the borate's water of hydration. For another example, the melt temperature may be selected to be high enough to produce adhesion and cause steaming of the water of hydration. That steaming may be used to cause foaming of the polymer fiber. Other mechanisms could be used to cause foaming of the polymer fiber including, for example, the introduction of a foaming agent such as sodium bicarbonate, calcium azide, or the like, prior to fiber quenching, regardless of whether a fire resistance additive is included. Alternatively, the borate additive may be introduced to the polymer fibers in a cooling bath after fiber formation, or even after such cooling but while the fiber surface is sufficiently warm, and thereby, sticky enough, to have borate in solid or liquid form adhere to the fiber surface before final cooling. The fire resistance additive may be integrated into the polymer fiber structure and also applied to the surface of the fiber.

The cellulose component of the composition comprises a plurality of fibers that are recycled fibers, virgin fibers, or a combination of the two. The source of the fibers is selectable and may include but not be limited to paper, OCC, and other cellulose fiber sources including annual plants. The cellulose component may also be or include cellulose residual matter, such as cellulose dust, microcrystalline cellulose, and/or nanofibrillated cellulose but not limited thereto. The cellulose component may be treated with one or more additives including, but not limited to, fire resistance additives, such as one or more borates, adherents, debonding agents, odorants, deodorants, and, optionally, one or more material expanders. The cellulose component may be supplied in the form of solid paper, tissue paper, a porous web, mats, etc. and may be delivered in sheets, fan folds, rolls, webs, mats, or other forms.

The composition of the present invention is a combination of the biomass-derived polymer and the cellulose component. The polymer and cellulose component are combined so that the polymer binds the cellulose to the polymer, or at least is used to establish a matrix configured to retain the cellulose component. For example, the composition may include a bonding agent that joins the cellulose component to the polymer. Alternatively, the polymer and the cellulose component may be combined while the polymer is in a melted or partially melted condition so that upon cooling and hardening of the polymer, the cellulose component adheres to it. Coupling of the cellulose component to the polymer may also occur through electrostatic coupling, covalent bonding, mechanically, or thermally. In that way, regardless of the form of the cellulose component, the cellulose component will be bound by the biomass-derived polymer. As a result, short fiber residuals, cellulose dust, cellulose crystallines, etc. as noted above may be used. Either or both of the polymer and the cellulose component may be treated with one or more additives, such as a fire resistant additive such as borate, prior to joining. The one or more additives may also be added to the composition after the joining of the polymer and the cellulose component.

The composition may optionally include expansible elements such as expansible microbeads. The microbeads may be expanded to increase the bulk of the composition, at the point of manufacturing, prior to delivery to the end-use site (such as by a distributor), or they may be expanded at the end-use site. The composition may include one or more other additives, such as one or more mold-control agents, odorants, deodorants, and debonding agents but not limited thereto. The composition may also include one or more coatings, such as oxygen barrier coatings, moisture barrier coatings, oil-resistant coatings, microbe-resistant coatings, etc. Some or all such additives and/or coatings may be added to the composition prior to delivery to an end-use site, at an intermediate site (such as a distributor) or after delivery to the end-use site.

The composition may be provided in a condition to enable its conversion into composition insulation while in the field. That condition may be a compacted form material, such as paper including folded paper, as well as mats of compressed composition. This minimizes the delivery costs, which otherwise could be higher if they were associated with transport of finished, lightweight, insulation. The composition may be generated in deliverable condition having a density and structure appropriate for producing a desired packing weight and thermal resistance. The composition may be modified at an intermediate site (such as a distributor) or at the end use site to reduce its bulk density, such as by expansion of one or more optional expansion component additives. The composition so modified (after expansion) may be referred to herein as composition-derived insulation. The composition-derived insulation may be expanded in the field such that the density of the composition-derived insulation is 20-95% lighter than the composition prior to any expansion.

The composition may be prepared offsite prior to delivery to a distribution an end-use site for further processing including, but not limited to, expansion. The composition may be modified in part rather than completely prior to delivery to the end-use site. That is, it may be partially or fully expanded prior to shipment to create internal voids. That porosity may be established using an expanded or expandible component, such as a foaming agent or microbeads as noted. That porosity may be established in the forming process, such as through through-air-drying. The composition may also include one or more of mold-control agents, debonding agents, odorants, and deodorants. Further, reactive zeolites may be integrated into the composition to reduce odor and/or to capture or react with one or more VOCs. The composition may be provided in rolls for ease of unwinding or in accordion folded sheet form that can be fed into automated processing equipment. It is not limited to those configurations.

As noted, a portion of the process for converting the composition may occur at a distribution site or the end-use site. For example, the composition may be processed at a distribution site or the end-use site to expand its volume by expanding the one or more optional expansion components. The composition may be infused with the expansion component, such as the microbeads, foaming of the polymer, or a foaming agent, for example, via application at the wet end of paper manufacturing or via addition of one or more such additives to the composition using a sizing press. Alternatively, the composition may be expanded by infusing the expansion component via a dry application and/or with a forced airflow through a porous configuration of the composition, thereby trapping the expansion component in the composition matrix, which acts as a filter to collect the expansion components.

The composition may be supplied suitable for forklift interactions and operator interactions to finish making or applying the packaging. A specific example of a suitable composition starter component is a 4 ft by 4 ft stack of fanfold paper 6 ft high on a skid or slip sheet for forklift interaction and with a pull tab on the top sheet to aid in operator initialization of the paper feeding to a composition processing machine located on site at an insulation distributor or an end-user location. The processing machine may be configured to feed the composition in a metered way for optional expansion component expansion and, optionally, for partial or complete shredding and/or aeration, and other steps require or desired for the production of composition-derived insulation with characteristics of interest. The expansion of an expansion component in the composition may be triggered by heat, which may be utilized to expand microbeads. The microbeads may contain a liquid that evaporates when the heat is applied, expanding the microbeads, and thereby expanding the composition. Further, thermal decomposition of a blowing agent at elevated temperatures could result in expansion forces that reduces composition density.

The composition may contain a foaming agent that expands when reacted with another component, which may be applied in the field. For example, an isocyanate/poly-isocyanate or blocked isocyanate base may be utilized that reacts with water, so that the addition of water in the field allows the composition to be expanded. Even a small fraction of expansible material may allow for a significant increase in the volume of the composition. If the metered composition is shredded and/or aerated, that may be done using one or more of spinning blades, pins, chains, and possibly other means to create a homogeneous mixture of polymer fibers, cellulose fibers, polymer-cellulose clumps, and voids. Additional treatments may be carried out to facilitate dust control, bulkiness, and cohesiveness, for example. A specific example might be mineral oil for dust control.

The composition and the option to field process it enables the production of insulation with a starter material that can be shipped in a much more compressed state of rolls, stacks of fanfold, or other configuration for ease of shipment rather than being shipped as low density pillows, three-dimensional geometries, or bulked paper sheets. The composition may be specifically designed such that upon expansion and any further optional processing, the finished insulation meets specific performance characteristics for density, thermal insulation, and/or other relevant performance characteristics.

Moisture and/or binders may be added in the field to create a stabilized product, meaning a product where cellulose fibers and/or residuals of the composition adhere to each other via bonding as the moisture evaporates. The moisture and/or binders may be added during, before, or after the expansion of the optional expansion component in converting the composition to composition-derived insulation. In particular, a binder may be included in the composition that is activated by the addition of moisture in the field, and then binds fibers together as they dry. Equipment to expand the composition may also include functionality to wet and then dry the composition in the process of converting the composition to composition-derived insulation.

The composition is provided in a condition to enable its conversion into the composition-derived insulation while in the field. That condition may be a compacted form of the composition, such as paper including folded paper, as well as mats of compressed fibers. This minimizes the delivery costs, which otherwise could be higher if they were associated with transport of finished, lightweight, cellulose insulation. The composition may be generated in deliverable condition having a density and structure appropriate for producing a desired R-value and fire resistance of the cellulose insulation formed. The composition-derived insulation may be a matrix of fibers including polymer and cellulose fibers with a bulk density of less than about 2.5 lbs/cu ft., with a critical radiant flux of greater than 0.12 W/cm², and a smoldering combustion rate of <15% per American Society of Testing and Materials (ASTM) test C739.

The composition may be modified in part rather than completely prior to delivery to the installation site. In addition to the polymer fibers and/or cellulose component being separately treated for fire resistance, the composition may also be treated with a fire retardant prior to installation and/or fire retardant materials may be added to the composition during conversion to composition-derived insulation. The application of fire retardants in the wet end of a paper-forming process may impact the fire resistance and mechanical properties of the composition differently than if that fire retardant or a different chemistry is applied via a sizing process after the composition has been formed. The application of the fire retardant materials may therefore be tuned in a way that is most advantageous for the precursor material.

The composition may have a porosity of 10% or more by volume. That porosity may be established using an expanded or expandible component, such as a foaming agent or microbeads as noted herein. The composition may also include one or more of debonding agents, odorants, and deodorants. Further, reactive zeolites may be integrated into the composition to reduce odor and/or to capture or react with one or more VOCs. The composition may be provided in rolls for ease of unwinding or in accordion folded sheet form that can be fed into automated processing equipment. It is not limited to those configurations.

As noted, a portion of the process for converting the composition may occur at the installation site. For example, the composition may be processed at the installation site to expand its volume by shredding and aeration. Alternatively, or in addition to shredding and aeration, the composition may be expanded in sheet form. The composition, its components, or both is or are treated with a fire retardant. The fire retardant may be applied via roll-to-roll processing by infusing a fire retardant material such as a liquid borate, for example, via a sizing press. The fire retardant may also or alternatively be applied by pressing dry-powder fire retardant onto a dry or moist composition surface. That is, the components of the composition can be treated with both liquid and powder fire retardant composition after sizing when partially and/or fully dried. The fire retardant may be selectively applied at any time in processing the composition including, but not limited to, when substantially in insulation form.

The composition of the present invention is a cellulose-based insulation wherein the cellulose component is bound by a bio-based polymer, biodegradable polymer, or lignin-based binder. The ratio of cellulose component to polymer material is selectable, recognizing that the end product of an insulation product should be low density. In that regard, the composition insulation is anticipated to be light and fluffy. Using polymer in the form of fibers aids in accomplishing that characteristic of the insulation, although it may also be accomplished with the polymer in a foam form. The insulation product of the invention is an insulating web wherein at least the cellulose component is treated with fire resistance additive such as borates in the basic structure of the cellulose component and where individual elements of the cellulose component are substantially bound together with the bio-based polymer, biodegradable polymer, or lignin-based binder for use as a precursor material in insulation applications.

The composition of the present invention may also be in batt form wherein either or both of the cellulose component and the polymer is treated with fire resistance additive such as borates in the basic structure of the component, and where individual elements of the cellulose component are substantially bound together with bio-based polymer, biodegradable polymer, or lignin-based binder for use as a precursor material in insulation applications. The batt provides for ease of transport of the composition. It may then be shredded at a location of interest and then used as loose fill insulation.

It is also noted that the use of the biobased polymer in fiber or other form provides a mechanism to retain and thereby recover cellulose dust by adhering that dust to the polymeric material. In that form of the composition of the present invention, the cellulose dust may be a portion or all of the cellulose component. Further, expansion components such the microbeads described herein may also or alternatively be used to retain and thereby recover cellulose dust by adhering that dust to the microbeads. In that form of the composition of the present invention, the cellulose dust may be a portion or all of the cellulose component.

The composition of the present invention leverages emerging chemistry from biorefining and polymerization processes to create hybrid materials with the following benefits: 1) lesser carbon footprint than conventional foams or fiberglass; 2) an ability to capture VOC's and/or formaldehyde that may be emitted by other materials; 3) greater resistance to heat flow than traditional cellulose (which may be provided by foams incorporating both bio-based polymer fibers and/or foams with cellulose); 4) greater cohesion, lower dust, and greater flexibility than traditional cellulose (due to the binding and flexible nature of these bio-based polymers); and 5) certain intermediate chemistries from the biorefining process may be useful as binders in assembling clumps of fibers. These small clumps may be useful in maintaining a light density in the end product, and similar binders may also be useful in forming boards or batts. The composition may be considered “carbon light” or even “carbon negative.” The composition enables the formation of insulation including a biomass-derived polymer to bind cellulose components together. The polymer allows for the optional thermoforming and/or sealing of the insulation product. The composition provides a precursor for such insulation as it can be modified in the field including, optionally, expansion thereof. The composition may be provided in sheet, roll, or compressed form.

### BRIEF DESCRIPTION OF THE DRAWINGS

FIG. 1 is a simplified side view of an example system to convert a composition comprising biomass-derived polymer and cellulose component into composition-derived insulation.

FIG. 2 is a cross-sectional side view of a simplified representation of an embodiment of the composition of the present invention with biomass-derived polymer fibers, cellulose component fibers, and fire resistance additive.

FIG. 3 is a simplified cross sectional side view of the precursor-derived cellulose insulation formed with the composition after processing in the composition processing machine.

FIG. 4 is a simplified cross sectional representation of an embodiment of the composition before and after expansion.

FIG. 5 is a simplified representation of one mechanism for expanding an embodiment of the composition including microbeads as an agent to expand the composition.

### DETAILED DESCRIPTION OF THE INVENTION

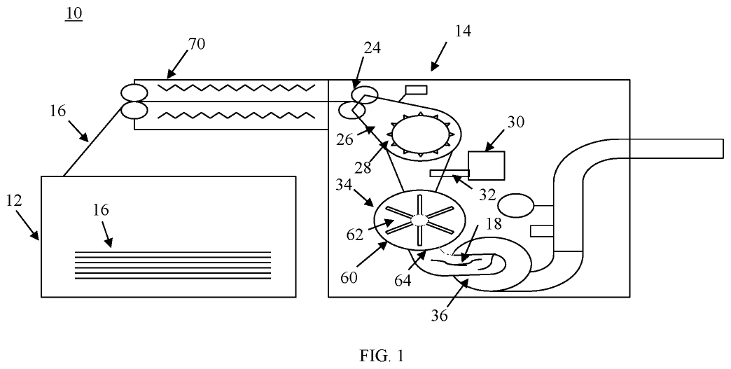

A system 10 for converting a composition 16 including a biomass-derived polymer and a cellulose component of the present invention into a composition-derived insulation 18 of the present invention is shown in FIG. 1. The system 10 includes a composition supply 12 and a composition processing machine 14. The machine 14 is enabled to produce the composition-derived insulation at an installation site or at a pre-installation site. The machine 14 may be used to carry out a portion of the steps associated with converting the composition on-site and off-site.

The supply 12 may be a container, pallet, or other apparatus for retaining thereon the composition 16 for making the insulation 18. The composition 16 may be any of the mix of components described herein in a loose form, a bound form, a sheet form, a batt form, and/or a foam form.

The composition 16 is conveyed by transfer component 24 into inlet 26 of the machine 14. The transfer component 24 may be a conveyor belt or band, or other type of material transport device arranged to move the composition 16. It may be a roller set when the composition 16 is in roll form. A plurality of transfer components may be used to deliver one or more sets of the composition 16 to fiber separation and aeration system 28.

The fiber separation and aeration system 28 is arranged to convert the composition 16 into a plurality of fibers. The fiber separation and aeration system 28 may be a shredder, an impeller, a fiberizer and/or an aerator or other type of fiber separation and aeration system as described herein. Multiple stages of separation and aeration may be used. The fiber separation and aeration system 28 shown represents one or more components that may be used to separate and aerate the composition 16, reducing its density to produce the insulation 18. One or more additives may be applied to the composition 16, the composition-derived insulation 18 in entering or exiting the fiber separation and aeration system 28 or both. The one or more additives may be supplied from additive supplier 30, which represents one or more additive supply containers. The additive supplier 30 may include one or more outlets 32 for delivery of the one or more additives. Output 34 of the system 28 is coupled to an insulation transfer component 36. The one or more additives may include, but are not limited to, fire retardancy material, odorants, deodorants, moisture supply, and debonding agents.

The system 10 optionally includes airlock 60 positioned between the fiber separation and aeration system 28 and the transfer component 36. The airlock 60 includes an inlet 62 coupled to output 34 of the fiber separation and aeration system 28, and an outlet 64 coupled to inlet 42 of the transfer component 36. The optional airlock 60 is configured to minimize feedback of insulation 18 into the fiber separation and aeration system 28.

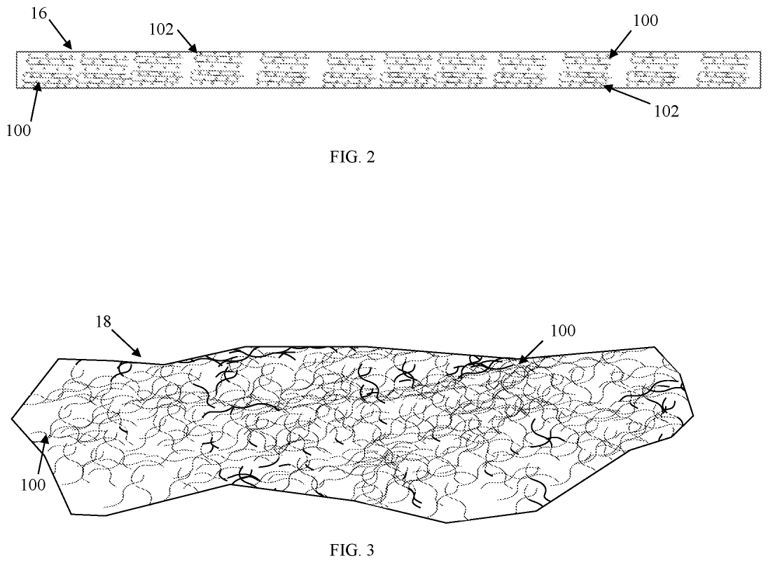

As shown in FIG. 2, the composition 16 is represented as a combination of compacted fibers 100. There may be one or more additives 102 dispersed through the fibers 100. The one or more additives 102 may optionally include an expansion component arranged to cause expansion of the composition 16 while passing through the fiber separation and aeration system 28. The composition 16 comprising the compacted fibers 100 and any additives 102 may be in sheet or roll form for ease of transport and delivery into the fiber separation and aeration system 28. As shown in FIG. 3, the composition-derived insulation 18 formed by the composition 16 passing through the fiber separation and aeration system 28 is porous. It has characteristics as described herein suitable to function as an effective substitute for existing insulation products.

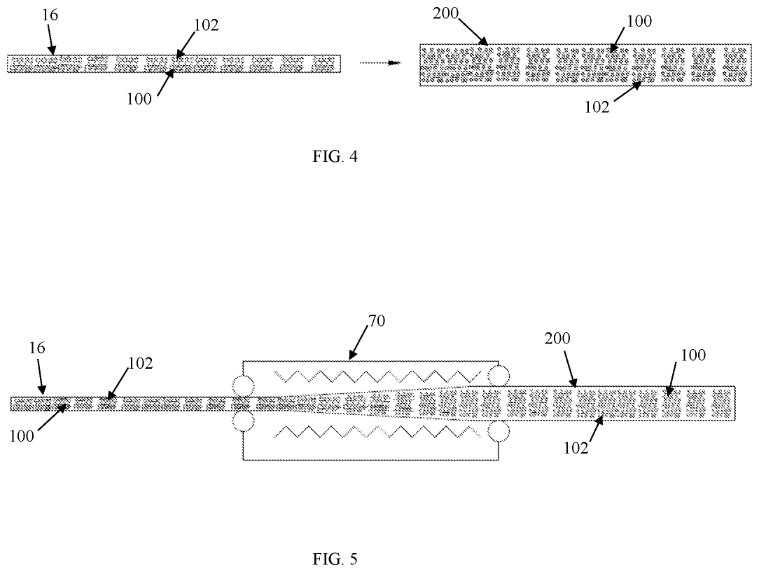

The fiber separation and aeration system 28 may include an expander component 70 arranged to cause the composition 16 in compressed form to expand. The optional expansion component may be a plurality of microbeads. FIG. 4 represents an illustration of the appearance of the composition 16 before and after passing through the expander component 70, wherein the expansion component is activated to cause it to expand with sufficient force to reduce the density of the composition 16 and thereby form expanded composition 200.

An example expander component 70 is shown in FIG. 5. The example expander component 70 is a heater over, through, or under which the composition 16 passes, wherein the composition 16 includes a plurality of microbeads as an additive. The heater is configured to generate enough heat imposed on the composition 16 to cause the microbeads to expand the volume of the composition 16, resulting in reduced density thereof. While the heater 70 is shown positioned prior to separation and aeration, it is understood that it may be positioned after that section of the system 28. The expander component 70 is generally configured to convert the composition 16 including an expansion component additive, such as a foaming agent or expandible beads, for example, into expanded composition 200. The foaming agent may be reactive to heat or moisture, for example, to cause it to convert from a fluid form, such as a liquid, into a foam form. The foam formed may remain within the dimensions of the composition 16, or it may extend beyond those dimensions. The expandible beads may be expanded by the application of heat but not limited thereto. For example, the expandible beads may contain a liquid that evaporates when heat is applied as that evaporation gases expands the beads, thereby expanding the composition 16 with those beads. The expander component 70 may therefore be a heater, a foam activator, a moisture delivery component, or any combination thereof.

The composition 16 includes the combination of a plurality of biomass-derived polymer fibers and a plurality of cellulose components as noted. The biomass-derived polymer fibers may be polyester, PET, polypropylene, polyethylene, or the like. The polymer fibers may be treated with a fire resistance additive, such as a borate but not limited thereto. The polymer fibers may be treated with borates introduced as part of the fiber melt process known to those of skill in the art. The selection of melt temperature can be such that borates maintain their waters of hydration when extruded. Alternatively, the selection of melt temperature can be such that borates give up their waters of hydration when extruded with the steam being a foaming agent introduced in aqueous solution such as cooling water or subsequent to formation of fibers.

The polymer fibers may be treated with borate powder adhered to the fiber surface. That is, while the surface of the polymer fiber is still hot, borate powder may be adhered to the fibers. The polymer fibers may have a round cross section, they may be hollow tubes, hollow square channel, or letter shaped, for example. The fibers may be foamed with foaming agent during the polymer melt process. The water of hydration of the borates may be used as a foaming agent. The agent for foaming the polymer fibers may be any one or more of sodium bicarbonate, ammonium carbonate, ammonium bicarbonate, calcium azide or other traditional foaming agents.

The cellulose components of the composition 16 may be fibers, short fiber residuals, cellulose dust, microcrystalline cellulose, nanofibrillated cellulose, or any combination thereof. The cellulose components may be recycled cellulosic material, virgin cellulosic material, or a combination of the two.

The composition 16 may alternatively include the combination of a biomass-derived polymer foam and the plurality of cellulose components. The polymer of the biomass-derived polymer foam may be polyester, PET, polypropylene, polyethylene, etc. The foam may be treated with the fire resistance additive. The foam may be treated with additive introduced as part of the melt. Selection of the melt temperature can be such that borates maintain their waters of hydration when the polymer fiber precursor of the foam is extruded. Selection of melt temperature can alternatively be such that borates give up their waters of hydration when polymer fiber precursor is extruded, with the steam being a foaming agent introduced in aqueous solution such as cooling water or subsequent to formation of the foam. The foam may be treated with borate powder adhered to the foam surface. For example, the borate powder may be adhered to the foam surface while the foam is hot.

The cellulose components may be joined to the foam while the polymer fibers are in a melted state before foaming. The cellulose components may be joined to the foam while it is cooling. The cellulose components may be joined to the foam with a binder after foam formation, which binder also may be used to join the cellulose components of the first embodiment of the composition 16 with the biomass-derived polymer fibers. The binder may be any one or more of starches, polyvinyl acetate, polyvinyl alcohol, lignin, natural rubber, or latex. The cellulose components may be applied with the binder subsequent to the foam being formed, including by softening the foam with heat prior to the joining. The cellulose components may be mixed with the foam prior to foam solidification. The foam may be formed into a specific cross section that is not round. It may be in the form of any one or more of a thin flat sheet, a rigid board, a hollow tube, a hollow square channel, a letter shape, a peanut shape, or any combination thereof. The foam may be formed using a blowing agent derived from furfural precursors. The foam may be enhanced with an emulsifier derived from furfural precursors.

The cellulose components joined with the polymer foam may be fibers, short fiber residuals, cellulose dust, microcrystalline cellulose, nanofibrillated cellulose, or any combination thereof. The cellulose components combined with the foam may be recycled cellulosic material, virgin cellulosic material, or a combination of the two.

Another embodiment of the composition 16 includes a plurality of biomass-derived polymer fibers, a plurality of cellulose components, and a plurality of expansion material additives of the type described herein. The expansion additives are dispersed throughout the composition 16. The expansion additive is selected to cause expansion of the composition while the composition passes through an expander apparatus such as the expander apparatus 70 shown in FIG. 5. The composition comprising the expansion additives may be in sheet or roll form for ease of transport and delivery into the expander apparatus 70. The composition may include adhesion and/or release coatings and/or these may be modified in the field.

The expander apparatus 70 may be arranged to cause the precursor material 16 in compressed form to expand. The expansion component additive may be a plurality of microbeads.

Composition web or sheets can optionally be mechanically embossed with twin matched geared embossing cylinders conforming the composition into a desired textured web. Deformation will increase the dimensional caliper of the composition. Embossing can also be conducted with an engraved cylinder and a resilient backing roll. Use of vacuum assisted embossing can also be used to develop higher Z-directional embossing depths. Composition embossing can take place in-line during pre-cursor production prior to volumetric expansion or at the end-use site prior to volumetric expansion by methods described above. Embossing patterns can range from ribs, pleats, waves, dimples, bumps, or any other three-dimensional texture suitable for increasing caliper. Embossing depths could range from 100 um to 3000 um or as much as 5000 um and may require moisture addition or pre-heating to improve compliance in an embossing nip. The embossing of a batt increases the caliper and impact of a three-dimensional structure of the batt. The nip of the embossing apparatus may be set at a temperature below a softening point of the biomass-derived polymer. The nip of the embossing apparatus may be set at a temperature above a melting point of the biomass-derived polymer to create a matrix of heat-sealed seams around non-embossed regions of the batt. The embossed composition can be used as is or vertically stacked to form a multi-layered insulation structure where the stacked embossing pattern develops voids in the stacked construction. Embossing textures that prevent interlocking of the stacked sheets is preferred to improve development of voids in the multi-ply laminate. Alternatively, the embossed composition sheets can be stacked in a transverse orientation further developing void pockets in the multi-sheet laminate. Void volume in layered assemblies can be filled with loose fill insulation which may also include binders and bonding agents, such as starch, polyvinyl acetate, or polyvinyl alcohol, for example, to create a durable post-formable matrix.

Use of a creping process is a further method to increase caliper of the composition prior to or following optional composition expansion and subsequent shredding to product the insulation. Secondary processing of a post-expanded composition could utilize moisture or binding agent to sufficiently adhere the composition to a metal cylinder. Upon release from the metal drying cylinder, most often termed a Yankee dryer, the creping process will disrupt or break weak intermolecular forces established during composition consolidation or expansion stages and allow the composition sheet or web to expand in the Z-direction so that the composition layers become partially separated. The ensuing micro-folds associated with crepe processing establishes a cross-sheet ribbing or crepe bar. These cross-sheet bars are in the order of 10-50 per linear cm. The creped composition can be used as is or stacked in the Z direction to form a multi layered insulation structure where the crepe bars overlap and develop voids in the stacked construction. Alternatively, the creped composition sheets can be stacked in a transverse orientation further developing void pockets in the multi-sheet insulation laminate. Void volume in layered assemblies can be filled with loose fill insulation which may also include binders and bonding agents, such as starch, polyvinyl acetate, or polyvinyl alcohol, or the like to create a durable post-formable matrix.

A variety of mechanisms for binding the cellulose component and the biomass-derived polymer have been described herein. Optionally, those components of the composition 16 may be bound together with a carbon-negative binder such as furfural alcohol but not limited thereto. The carbon-negative binder may be used to bind at least the cellulose components into microstructure clusters. Further, VOC and/or odor control additives may be added to the composition in the field or prior to transport. A VOC and/or odor control additive may be zeolite for the VOC control and an active catalyst such as zinc may the used as an odor absorber. The addition of zeolite the composition may yield an insulation that absorbs VOCs emitted by other building materials in the structure to be insulated, thereby rendering the insulation formed with the composition a VOC-negative insulation. The zeolite may be modified to be impregnated with a metal reactive with formaldehyde so as to neutralize formaldehyde that may exist in other building materials. The insulation may also be configured to capture other undesirable gases with high GWP.

The composition of the present invention provides a loose blown cellulose-based fiber insulation comprising biomass-derived polymer fibers and/or foam mixed with cellulose fibers wherein some or all of the fibers and/or foam are treated with fire retardants. The fire retardants may be applied to components of the loose blown insulation via one or more of: application of a liquid borate solution, application of solid borate powders, and the use of biomass-derived fire retardants. The density of the insulation formed with the composition as loose blown fiber insulation as installed ranges from about 0.8 to about 4.5 lbs./cubic foot. The composition of the present invention produces batts of insulation comprising biomass-derived polymer fibers and/or foam mixed with cellulose fibers wherein some or all of the fibers and/or foam are treated with fire retardants. The fire retardants may be applied to components of the batt insulation via one or more of: application of a liquid borate solution, application of solid borate powders, and the use of biomass-derived fire retardants. The density of the insulation formed with the composition as batt insulation as installed ranges from about 0.8 to about 4.5 lbs./cubic foot.

The composition of the present invention enables the formation of layered assemblies of insulation formed with the composition wherein at least one of the layers of the layered assembly includes the composition of the present invention comprising biomass-derived polymer fibers and/or foam mixed with cellulose fibers wherein some or all of the fibers and/or foam are treated with fire retardants. The fire retardants may be applied to components of the layered assemblies via one or more of: application of a liquid borate solution, application of solid borate powders, and the use of biomass-derived fire retardants. The layered assembly includes the at least one layer of composition sandwiched between two membranes or with one membrane as a backing membrane. One or two of the membranes may be manufactured from a biomass-derived polymer sheet but not limited thereto. Alternatively, one or two of the membranes may be manufactured from a kraft paper. The density of the layered insulation assembly formed with the composition as batt insulation as installed ranges from about 0.8 to about 4.5 lbs./cubic foot. The layered assemblies may be shredded to form loose blown insulation. Alternatively, the layered assemblies may be formed into a batt having multiple layers, with internal membranes within the batt parallel to the face of the batt. The layered assemblies may be cut to two forms, such that each of the two forms can be folded to sit against three sides of a six-sided box and serve as insulation within that box.

Boards of insulation formed with the composition of the present invention comprising biomass-derived polymer fibers and/or foam mixed with cellulose fibers wherein some or all of the fibers and/or foam are treated with fire retardants. The fire retardants may be applied to components of the layered assemblies via one or more of: application of a liquid borate solution, application of solid borate powders, and the use of biomass-derived fire retardants. The boards may be treated with biomass-derived Furfural Alcohol as a means of protecting the boards, while mitigating carbon impacts. The density of the insulation boards as installed ranges from about 2 to about 15 lbs./cubic foot.

1. An insulation composition comprising:
one or more biomass-derived polymer components;
one or more cellulose components; and
one or more fire retardants applied to at least a portion of either or both of the one or more biomass-derived polymer components and the one or more cellulose components.

2. The insulation composition as claimed in claim 1, wherein the one or more biomass-derived polymer components are in the form of either or both of fibers and foam.

3. The insulation composition as claimed n claim 1, wherein the one or more cellulose components are in the form of one or more of recycled fibers, virgin fibers, cellulose dust, microcrystalline cellulose, and nanofibrillated fibers.

4. The insulation composition as claimed in claim 1, wherein the one or more fire retardants are selected from liquid borate solution, solid borate powder, and biomass-derived fire retardant.

5. The insulation composition as claimed in claim 1, wherein the insulation composition is in a form of loose blown fiber insulation.

6. The insulation composition as claimed in claim 1, wherein the insulation composition is in a batt form.

7. The insulation composition as claimed in claim 1, wherein the insulation composition is in a form of layered assemblies.

8. The insulation composition as claimed in claim 1, wherein the insulation composition is in a board form.

9. The insulation composition as claimed in claim 1, wherein the one or more biomass-derived polymer components and the one or more cellulose components are bound together.

10. (canceled)

11. The insulation composition as claimed in claim 1, wherein the one or more cellulose components includes a plurality of cellulose fibers, the insulation composition further comprising one or more carbon-negative binders to bind the cellulose fibers into microstructures.

12. (canceled)

13. (canceled)

14. (canceled)

15. (canceled)

16. A method to make an insulation composition comprising one or more biomass-derived polymer components, one or more cellulose components, and one or more fire retardants, the method comprising the steps of:
binding a plurality of cellulose components together with a biomass-derived polymer to form a polymer-cellulose composition; and
adding a fire retardant to one or more of the cellulose components, the biomass-derived polymer, and the polymer-cellulose composition.

17. The method as claimed in claim 17, wherein the plurality of cellulose components comprises one or more of recycled fibers, virgin fibers, cellulose dust, microcrystalline cellulose, and nanofibrillated fibers, and wherein the biomass-derived polymer substantially binds the plurality of cellulose components together.

18. (canceled)

19. (canceled)

20. The method as claimed in claim 16, wherein a binder to bind the plurality of cellulose components and the biomass-derived polymer is selected from one or more of bio-based polymer, biodegradable polymer, and a lignin-based binder.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. The method as claimed in claim 16, wherein the plurality of cellulose components includes cellulose dust, further comprising the step of binding at least a portion of the cellulose dust in the insulation composition with at least a portion of a plurality of microbeads.

33. The method as claimed in claim 16, further comprising the steps of:
forming the insulation composition into a layered assembly comprising one or more layers of the insulation composition; and
sandwiching the one or more layers of the insulation composition between two membranes, wherein one of the two membranes is a backing membrane.

34. The method as claimed in claim 33, wherein either or both of the two membranes is made of one or more of biomass-derived polymer sheet and kraft paper.

35. The method as claimed in claim 33, wherein the biomass-derived polymer of the insulation composition is a foam.

36. The method as claimed in claim 34, further comprising the step of shredding the layered assembly to form loose blown insulation.

37. The method as claimed in claim 33, further comprising the step of forming the layered assembly into a batt having multiple layers, wherein the batt includes multiple batt layers spaced from one another by one or more internal membranes.

38. The method as claimed in claim 16, further comprising the step of forming the insulation composition into a board.

39. (canceled)
